(19) United States
(12) Patent Application Publication
(10) Pub. No.: US 2012/0107116 A1
(43) Pub. Date: May 3, 2012

(54) SYSTEM AND METHOD FOR DAMPING MOTION OF A WIND TURBINE

(76) Inventor: John M. Obrecht, Lafayette, CO (US)

(21) Appl. No.: 12/938,439

(22) Filed: Nov. 3, 2010

(51) Int. Cl. F03D 7/00; F03D 11/00

(52) U.S. Cl. 416/1; 416/145

(57) ABSTRACT

A system (40) for damping motion of a wind turbine (10a) is provided. The system (40) includes a sensor (42), a movable mass (44), an actuator (58), and a controller (46). The sensor (44) is operable to provide a signal representative of a motion of the wind turbine (10a) in one or more degree of freedoms. The movable mass (44) is associated with the actuator (58) and is disposed on a blade (24a) of the wind turbine (10a) and is configured for movement along a length of the blade. In response to the sensor (42), the controller (46) is operable to direct the actuator (58) to move the movable mass (48) along a length (50) of the blade (24) to a degree effective to dampen motion of the wind turbine (10a) in one or more degree of freedoms.

### FIELD OF THE INVENTION

The present invention relates to wind turbines, and more particularly to systems and methods for damping motion of a wind turbine.

### BACKGROUND OF THE INVENTION

Wind turbines continue to garner significant interest in view of the push for renewable energy worldwide. Typically, wind turbines include a rotor having multiple blades, a drive train and a generator housed in a nacelle, and a tower. The nacelle and the rotor are typically mounted on top of the tower. As the interest in wind turbines has developed, so has the interest in moving typical land-based wind turbines offshore. Wind turbines adapted for offshore (floating wind turbines) environments aim to make use of improved wind conditions and are particularly of interest where land is scarce or where land-based regulations are more stringent. Floating wind turbines typically include the same components as land-based wind turbines, but further include a floating platform upon which the rotor, nacelle, and tower are disposed. As is readily appreciated, a number of forces, including wind energy, wave energy, and forces due to the rotation of the rotor's blades will cause movement of the floating wind turbine. This movement of the floating wind turbine while in operation significantly reduces the efficiency of the floating wind turbine. Accordingly, improved systems and methods are needed to minimize movement of the floating wind turbine off-shore to achieve greater efficiency.

### BRIEF DESCRIPTION OF THE DRAWINGS

The invention is explained in the following description in view of the drawings that show:

FIG. 1 illustrates a typical prior art floating wind turbine.

FIG. 2 illustrates a schematic of the components of a nacelle in the prior art floating turbine of FIG. 1.

FIG. 3 illustrates a front view of the floating wind turbine and showing an X-axis and a Y-axis relative to the wind turbine in accordance with an aspect of the present invention.

FIG. 4 illustrates a floating wind turbine having a system for damping motion in accordance with an aspect of the present invention.

FIG. 5 illustrates a rotor blade having a movable mass in accordance with an aspect of the present invention.

FIG. 6 illustrates another rotor blade having a movable mass in accordance with an aspect of the present invention.

FIG. 7 illustrates another rotor blade having two movable masses thereon in accordance with an aspect of the present invention.

FIG. 8 is a schematic of a method for operating a wind turbine in accordance with the present invention.

FIG. 9 illustrates a motion damping system for a wind turbine within which the turbine's motion is approximated as a mass-spring system in accordance with an aspect of the present invention.

FIGS. 10A-10I show the results of simulating two simultaneously resonantly driven systems damping motion in an X and Y direction at the same time with one movable mass system.

FIGS. 11A-C show the results of an analytic solution used to direct motion of the movable masses in accordance with an aspect of the present invention.

### DETAILED DESCRIPTION OF THE INVENTION

In accordance with one aspect of the present invention, there are disclosed systems and methods for operating a wind turbine, which utilize one or movable masses (herein “movable masses”) disposed on one or more blades of the wind turbine to dampen motion in at least one degree of freedom. By “on,” it is meant that the movable masses are disposed on or within the rotor blade of the wind turbine. The systems and methods described herein are particularly suitable for floating or offshore wind turbines to dampen an up-down and/or a side-to-side motion of the floating wind turbine. It is understood, however, that the present invention is not so limited and that the systems and methods described herein may be applied as well to land-based wind turbines or other structures having a need for damping motion and/or mitigating extreme loading events therein.

In accordance with another aspect of the present invention, the movable masses on the blades act to create driving forces having a phase and a magnitude sufficient to simultaneously dampen oscillations of the wind turbine in a corresponding first direction and a second direction, e.g., an up-down and a side-to-side direction of the wind turbine. In one embodiment, a phase of the driving forces is determined by an X-Y location of the system's center of mass, while a magnitude of the driving forces is determined by the mass and inertia of the movable masses. The center-of-mass position for the associated wind turbine system may be actively controlled by moving selected ones (one or more) of the movable masses a particular distance (d) from the rotor center along an axis the blades as set forth below. The simulated model described and set forth herein show that the simultaneous damping of the motion of a wind turbine in two degrees of freedom may be achieved by utilizing aspects of the present invention.

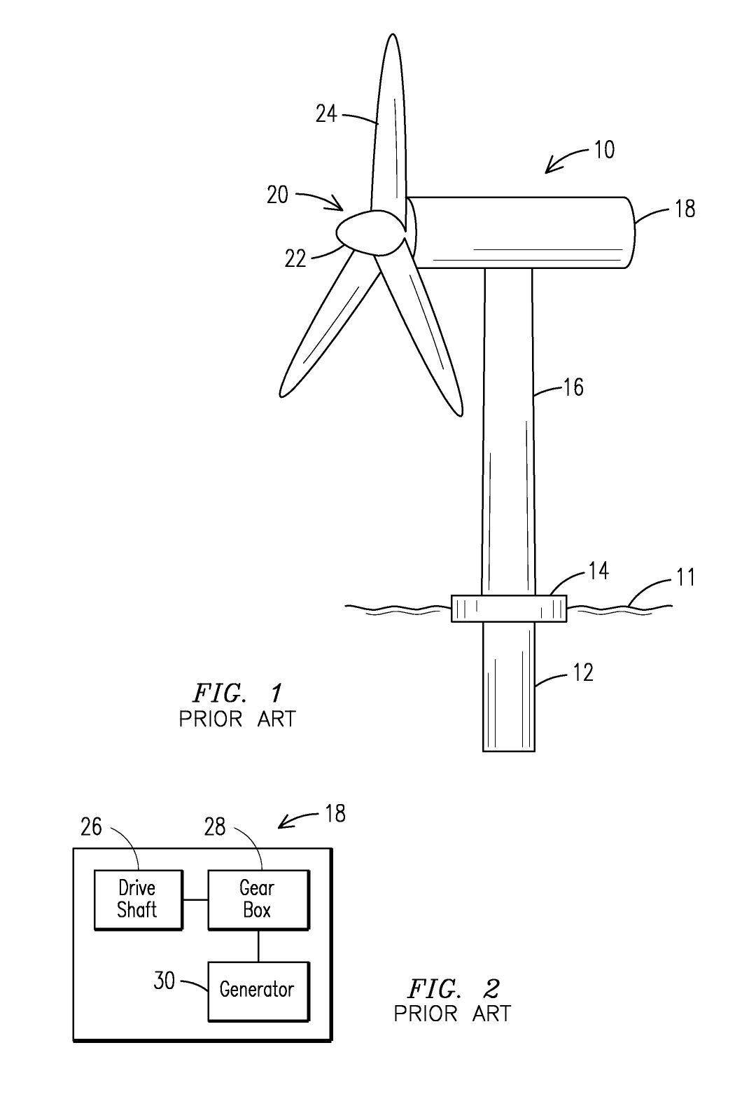

Referring to FIG. 1, FIG. 1 illustrates a floating wind turbine as is known in the art. As is shown, the floating wind turbine 10 rests in a body of water 11 and comprises a buoyant member 12, a floating platform 14, a tower 16 mounted on the floating platform 14, a nacelle 18 mounted on the tower 16, and a rotor 20 having a hub 22 and a plurality of rotor blades 24. As shown in FIG. 2, in one embodiment, the nacelle 18 comprises a drive shaft 26, a gear box 28 operably associated with the drive shaft 26, and a generator 30 operably associated with the gear box 28. It is understood, however, that the nacelle 18 is not so limited to containing these components. For example, in certain embodiments, the nacelle 18 may not include the gear box 28. In operation, the blades 24 of the rotor 20 transform wind energy into a rotational motion of the drive shaft 26. The drive shaft 26 thereafter rotates a rotor (not shown) of the generator 30. The gear box 28 steps up the relatively low rotational speed of the generator rotor to a more suitable speed for the generator 30 to efficiently convert the rotational motion to electrical energy. Typically, wind turbines comprise three rotor blades 24, although it is understood the present invention is not so limited.

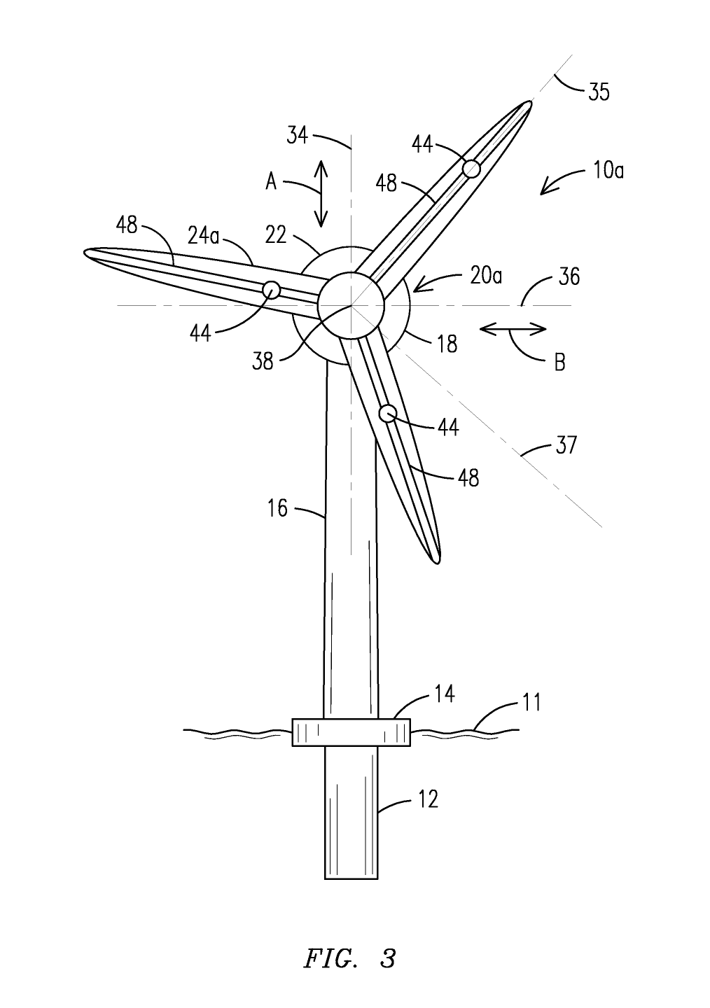

Referring to FIG. 3, there is shown a floating wind turbine 10a of the type described above now having a system 40 for damping oscillations incorporated therein. The system 40 includes movable masses 44 on each of the blades 24a as described below. Each movable mass 44 creates a center of mass imbalance along a length of its associated blade 24a. As shown by an exemplary one of blades 24a in FIG. 3, a center of mass imbalance will exist along a first axis 35 extending through the blade 24a. Further, a center of mass imbalance will exist along a second axis 37 that is perpendicular to the first axis 35 and which lies in a plane of the rotor 20. By adjusting one or more of the movable masses 44 to a predetermined degree and controlling the center of mass imbalance along each axis 35, 37, the center of mass of the system, e.g., floating wind turbine 10a, may be modified to help create driving forces that will simultaneously dampen oscillations of the wind turbine in a corresponding first direction and a second direction.

When the floating wind turbine 10a is disposed within a body of water 11, the floating wind turbine 10a will typically oscillate at a specific frequency in the first direction, e.g., an up-and-down movement of the floating wind turbine along an X-axis 34 as shown by bi-directional arrow A. In addition, it is expected that the floating wind turbine 10a will oscillate at a specific frequency in the second direction, e.g. side-to-side movement along a Y-axis 36 as shown by bi-directional arrow B. In one embodiment, the X-axis 34 may be defined as a line or axis extending vertically through or parallel to the tower 16 and the nacelle 18 and/or may be defined as an axis that is perpendicular to the Y-axis 36. The oscillations along the X-axis 34 would be expected at least as a result of buoyant forces acting upon the floating wind turbine 10a. The oscillations along the Y-axis 36 would be expected at least due to forces from wind energy and wave energy.

It is understood that aspects of the present invention are not limited by these definitions of the X and Y axes, but it is critical rather that there exists an axis in a first degree of freedom (e.g., along the X-axis 34), a second degree of freedom (e.g., along the Y-axis 36), or both. As will be further explained herein, aspects of the present application will servo the floating wind turbine 10 back toward a reference point, e.g., a reference point 38, at an intersection of the X-axis 34 and the Y-axis 36 using driving forces created by movable masses on the blades 24.

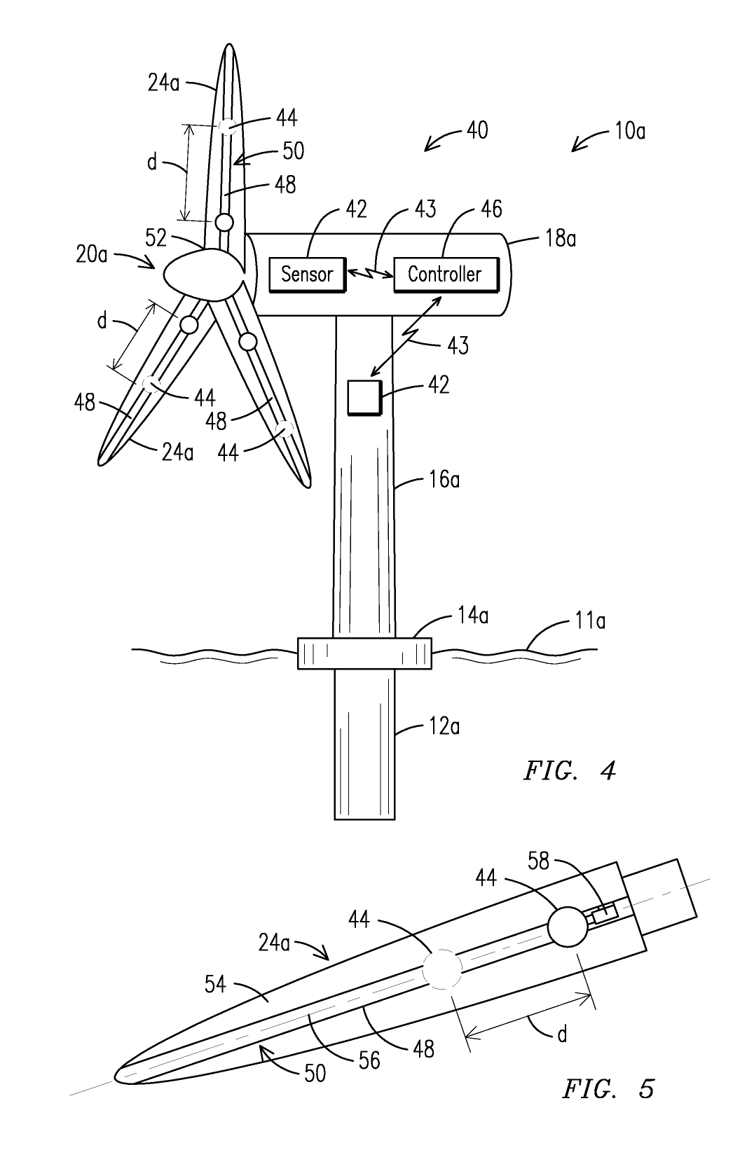

Referring now to FIG. 4, there is shown more fully the system 40 for dampening oscillations, which may be incorporated into a wind turbine. In one embodiment, the system 40 may be incorporated into an existing wind turbine, such as that shown in FIG. 1. In another embodiment, the wind turbine may initially be manufactured with the system 40 therein. The system 40 within wind turbine 10a includes sensors 42, movable masses 44 disposed on at least one of the blades 24a of the rotor 20a, and a controller 46 in communication with the sensors 42 and the movable masses 44. Collectively, the sensors 42, movable masses 44, and the controller 46 may provide the predetermined driving forces necessary to quench motion of the wind turbine 10 in two degrees of freedom, e.g., along the X-axis 34 and the Y-axis 36 as shown in FIGS. 3 and 9. The sensors 42 comprise one or more sensors for determining an extent of movement of the wind turbine 10 in one or more degrees of freedom, e.g., along the X-axis 34 and the Y-axis 36. Typically, the sensors 42 are configured to sense one or more of a frequency, amplitude, and phase of one or more oscillations of an associated body, e.g., wind turbine 10a, in one or more degrees of freedom.

In one embodiment, the sensors 42 comprise one or more accelerometers configured to measure oscillations of the wind turbine tower 16 and/or nacelle 18, due to a force of wind striking the tower, wave energy, and the like along the X-axis 34 and the Y-axis 36. In another embodiment, the sensors 42 include or further include gyroscopic sensors to obtain a tilted position of the wind turbine 10a, e.g., a tilted position of the tower 16. In yet another embodiment, the sensors 42 may comprise a global positioning system (GPS), which is particularly suitable to obtain a position of the wind turbine along the X-axis 34. For example, the sensor 42 may be configured to determine a magnitude in which a reference point on the wind turbine 10a, e.g., a reference point on the tower 18, lies above sea level at a particular moment in time.

The sensors 42 may be disposed on the wind turbine 10a at any suitable location for determining the oscillations of the wind turbine 10 relative to the X-axis 34 and the Y-axis 36. In one embodiment, one or more sensors 42 are disposed on the tower 16 and the nacelle 18 as shown so as to sense oscillations of the floating wind turbine 10 along the X-axis 34 and the Y-axis 36. Typically, the sensors 42 will convert the sensed accelerations to an electrical signal, signal 43, which may be transmitted to the controller 46 by any suitable wired or wireless connection. The signal may be representative of a magnitude and a phase of motion of the wind turbine 10 in one or more degrees of freedom. The controller 46 will utilize the received information (from the sensors 42) representing the movement of the wind turbine 10 in one or more degrees of freedom to determine (via a forcing function) the extent to which one or more movable masses 44 in the blades 24a will be moved to dampen motion of the floating wind turbine 10 along the X-axis 34 or the Y-axis 36, or both. Via movement of at least one of the movable masses 44 associated with the blades 24a of the rotor 20a, the system 40 is able to dampen motion of the floating wind turbine 10a in one or more degrees of freedom.

The movable masses 44 may be of any suitable size, shape, and mass suitable for the extent of motion to be dampened. One or more of the blades 24a of the wind turbine 10a may include a movable mass 44. In one embodiment, each of the blades 24a comprises a movable mass 44 as described herein. The movable masses 44 may be disposed on (on or within) the blades 24a in any suitable configuration. In one embodiment, for example, the movable masses 44 each comprise a fifty (50) kg mass, each which is configured to move a distance (d) along a track 48 disposed along a length 50, e.g., a longitudinal axis, of the associated rotor blade 24. Each movement of a movable mass 44 on a corresponding blade 24a is effective to change a center of mass of the corresponding blade 24a. It is understood that for each blade 24a having a movable mass 44, the movable mass 44 may refer to a single body or, in another embodiment, to two or more bodies whose masses are combined for purposes of reference and/or for determining the extent to which the movable mass 44 will travel along a length of the blade 24a. The movable masses 44 may move toward or away from a predetermined point along the length 50 of its associated blade 24 as instructed by the controller 46. For example, in one embodiment, the movable masses 44 move the distance (d) away from the blade root 52 of the rotor 20a. Typically, the movement of the movable masses 44 is relatively linear along the length 50 of the blade 24a, but aspects of the present invention are not so limited.

In one embodiment, as shown in FIG. 5, an exemplary blade 24a from the system of FIG. 4 is shown as having a body 54 having a length 50 that extends along a longitudinal axis 56 of the blade 24a. In addition, the exemplary blade 24a includes a movable mass 44, the track 48, and an actuator 58 that interfaces or is associated with the movable mass 44. In one embodiment, the actuator 58 is provided on the track 48 and in communication with the controller 46 and that is operably associated with each of the movable masses 44 to move the movable mass 44 a distance (d) along the length of the associated blade 24. The actuator 58 may be any suitable pneumatic actuator, hydraulic actuator, motorized actuator, or other actuator known in the art.

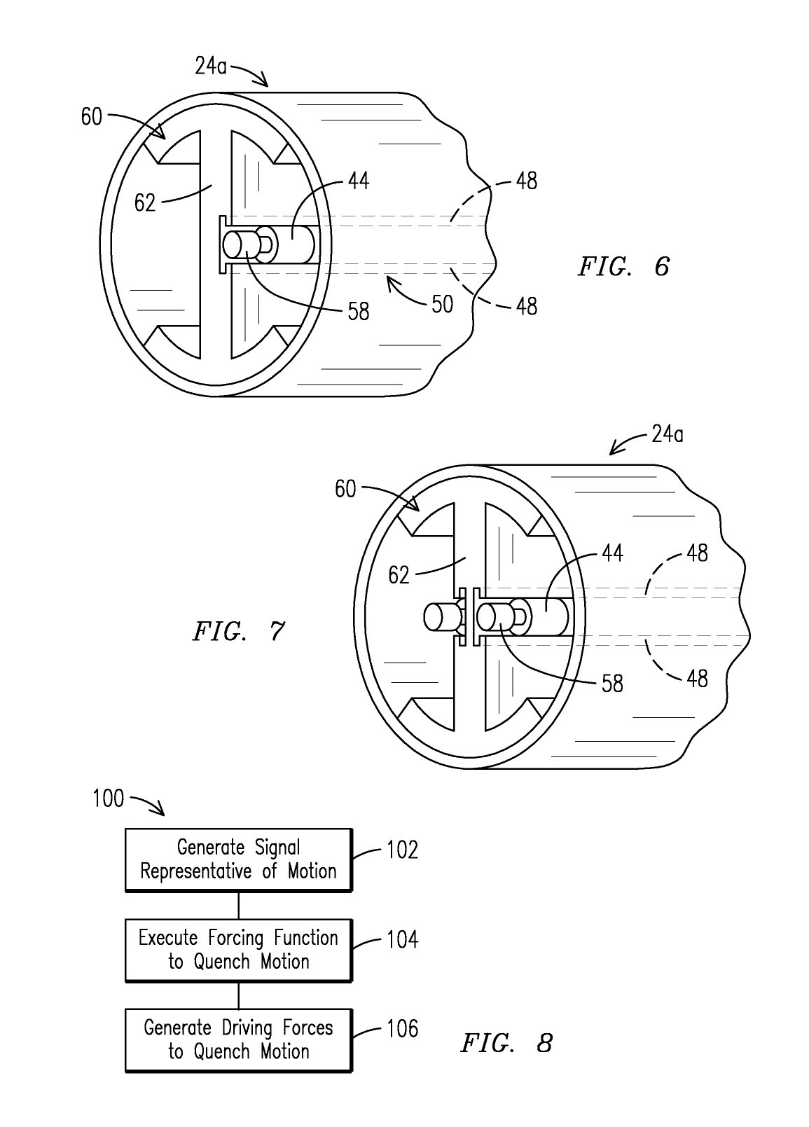

In a particular embodiment, as shown in FIG. 6, exemplary blade 24a comprises a spar, e.g., an I-shaped spar 60 having a vertical post 62 that extends along the length 50 of the corresponding blade 24. A track, e.g., track 48, is disposed along the longitudinal length of the I-shaped spar 60. An exemplary movable mass 44 is disposed on the track 48 and is configured to move along the track 48. The actuator 58 is operably associated with the moveable mass 44 to move the movable mass 44 a predetermined distance (d) along the track 48 in response to a command from the controller 46. In one embodiment, as shown in FIG. 6, a movable mass 44, a corresponding track 48, and the actuator 58 are provided on one side of the I-shaped spar 60. In another embodiment, as shown in FIG. 7, a movable mass 44, tracks 48, and one or more actuators 58 are provided on opposed sides of the I-shaped spar 60. Providing a movable mass 44 on opposed sides of the I-shaped spar 60 as in FIG. 7 allows for a more even mass distribution throughout the blade 24. In one embodiment, the two opposed movable masses 44 are of substantially the same mass so as to prevent an asymmetric weight distribution to the blade, as well as allowing for a smaller actuator system. The movable masses 44 on each side of the I-shaped spar 60 may be recognized as a single mass for reference and for determining the extent to which the movable masses 44 require movement in order to dampen oscillations of the associated structure, e.g., floating wind turbine 10.

In another embodiment, the two movable masses 44 each act as an independent system on a single blade. In one embodiment, a first movable mass 44 is larger in mass than the second movable mass 44. The first movable mass 44 may be used for low-frequency drive motion while the second smaller mass 44 may be used for high-frequency drive motion. In yet another embodiment, the first (larger mass) movable mass 44 may be used for a course correction while the second (smaller) movable mass 44 may be used for a fine correction. In still another embodiment, a first and a second movable mass 44 may be substantially identical or identical in mass as described above. In such an embodiment, the first movable mass 44 could be used for small wave-wind disturbances and the second movable mass 44 could be used for large wave-wind disturbances.

Referring again to FIGS. 3-4, the controller 46 is configured to execute computer readable instructions for establishing a forcing function to quench motion of the floating wind turbine in one or more degrees of freedom. To accomplish this, the controller 46 comprises one or more inputs for receiving information from the one or more sensors 42. Utilizing the input information and the forcing function, the controller 46 is programmed to instruct the actuator 58 to move one or more of the movable masses 44 on the blades to create driving forces sufficient to dampen motion in one or more degrees of freedom, e.g., along the X-axis 34 and the Y-axis 36. Thus, the extent of movement (distance (d)) of a movable mass 44 on or within each blade 24a is automated and governed by the controller 46. In one embodiment, the controller 46 is configured to move selected ones of the movable masses 44 a desired extent along a length of the blades 24a from the blade root 52 of the track 48. In addition, it is contemplated the controller 46 may receive signals representative of other data necessary to determine the driving forces necessary on two coordinate axes to servo the floating wind turbine 10 toward a predetermined reference point, e.g., reference point 38. In one embodiment, for example, the controller 46 may actively stabilize the X-Y position of the floating wind turbine 10 relative to a position of the waves or servo to a position of the sea floor.

The controller 46 may comprise, for example, a special purpose computer comprising a microprocessor, a microcomputer, an industrial controller, a programmable logic controller, a discrete logic circuit or other suitable controlling device. In one embodiment, the controller 46 comprises input channels, a memory, an output channel, and a computer. As used herein, the term computer may include a processor, a microcontroller, a microcomputer, a programmable logic controller (PLC), an application specific integrated circuit, and other programmable circuits. The memory may include a computer-readable medium or a storage device, e.g., floppy disk, a compact disc read only memory (CD-ROM), or the like. The controller 46 comprises computer readable instructions for determining the extent to which one or more movable masses 44 on the blades 24 must be moved to dampen oscillations of the floating wind turbine 10 in one or more degrees of freedom, e.g., along the X-axis 34 and the Y-axis 36.

In accordance with another aspect of the present invention, there is provided a method 100 for operating a wind turbine, e.g., floating wind turbine 10a, having a plurality of blades 24a utilizing the system 40 described herein. As shown in FIG. 8, the method comprises step 102 of generating a signal representative of a magnitude and a phase of motion of the wind turbine 10a in at least one degree of freedom via at least one sensor 42. The method 100 then comprises step 104 of executing a forcing function in response to the generated signal effective to determine driving forces necessary to quench the motion of the wind turbine in at least one degree of freedom. In one embodiment, the method further comprises step 106 of generating the driving forces by moving masses 44 disposed on at least one of the plurality of blades 24a a predetermined distance as determined by the forcing function to quench the motion of the wind turbine in at least one degree of freedom. In a particular embodiment, the motion of the wind turbine is quenched in a first degree of freedom and a second degree of freedom simultaneously.

It is understood that aspects of the present invention may actively servo (stabilize) the X-Y position of floating wind turbines. It is understood, however, that the systems and methods described herein may be applied as well to dampen motion or mitigate extreme loading events of land-based wind turbines. In the latter case, it would be expected that there may be no oscillations in the up-down direction to be dampened, however extreme loading events could be lessened. It is also noted that a mass system in the tower 16 of the floating wind turbine 10a, for example, could dampen the up-down motion, while a mass system in a stationary (horizontal) blade would dampen side-to-side motion. However, in a moving system like a floating wind turbine 10a described herein, the movable masses 44 have to move in such a way as to have their inertial forces properly decompose to the stationary frame (e.g., the tower and nacelle 18) of the wind turbine 10a. Accordingly, the X-Y inertial forces from the movable masses 44 should be mathematically identical or substantially identical to the oscillations on the floating wind turbine 10, for example. These inertial forces in the moving frame are taken into account in the simulation below. As explained above, the controller 46 will determine the extent and amount to move the movable masses 44 on or within one or more of the blades 24a to create damping forces sufficient to quench movement of the floating wind turbine 10a. The following simulation and non-limiting example illustrates that the above-described systems and methods may be utilized to stabilize the position of a floating wind turbine for any waves or excited motion.

### Example

Coordinate-System Definitions

The coordinate system and definitions used in the simulation of this system are set forth below. In this simulation, the turbine's tower and nacelle are modeled as a single mass M, whose vertical and horizontal position are defined as X (34) and Y (36) respectively. As shown in FIG. 9, the rotor 20a (of the turbine) rotates with an angular velocity Ω in the θ direction. The rotor 20a has a mass m_{R} and a mass-moment of inertia I_{R}. Within each blade of the turbine's rotor is a mass 44 (m), which is free to move along the interior of the blade at variable distance (r) from the rotor's center.

Controlled Damping Mechanism

As explained above and shown in the figures, the masses 44 may be independently moved along their respective axes in a prescribed fashion in order to accomplish the desired effect of creating a pair of driving forces (in both the X and Y direction) that are resonant with the vertical and horizontal motion of the associated turbine, respectively. FIG. 9 shows the simplified model of a floating turbine system in which the turbine's motion, e.g., motion of the floating wind turbine 10a, is approximated as a mass-spring system, whose frequencies (ωᵢ) are set by the spring constants k_{X} and k_{Y}, and the total mass m_{T} of the system: kᵢ=m_{T}ωᵢ², where i=X and Y.

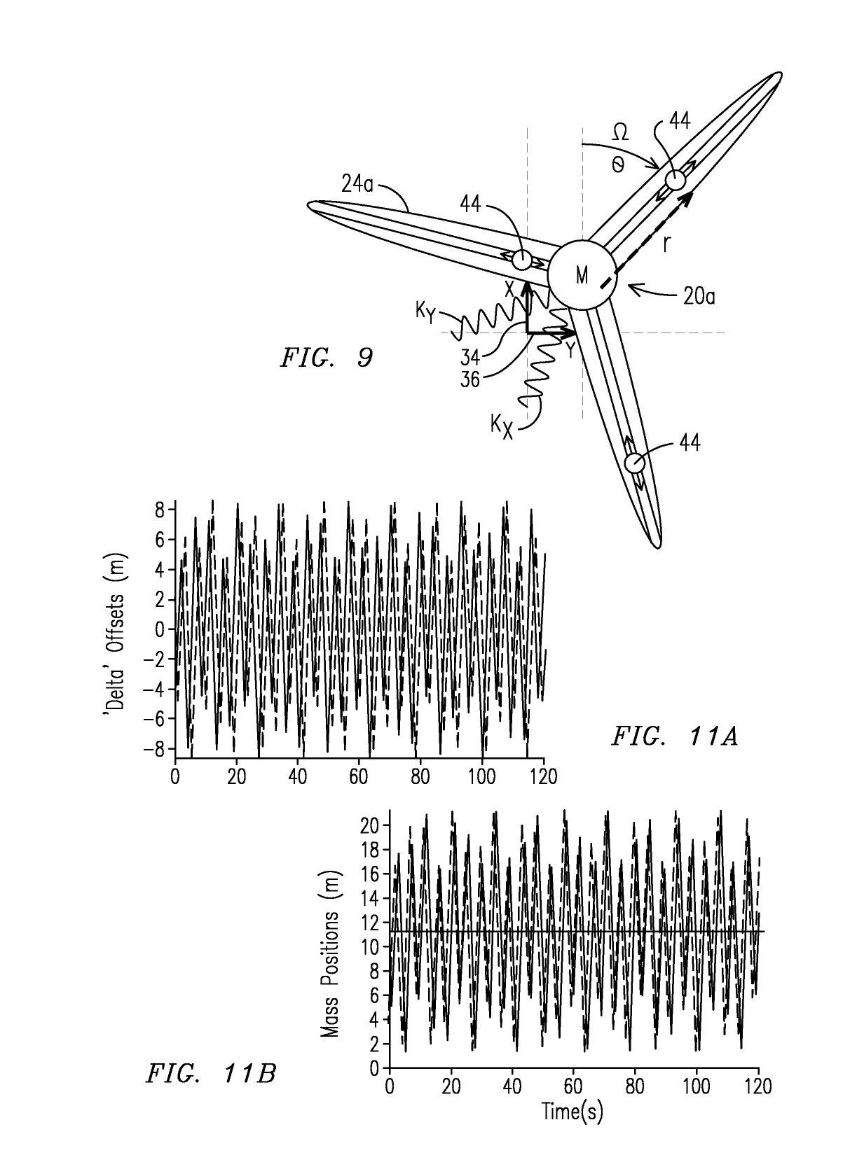

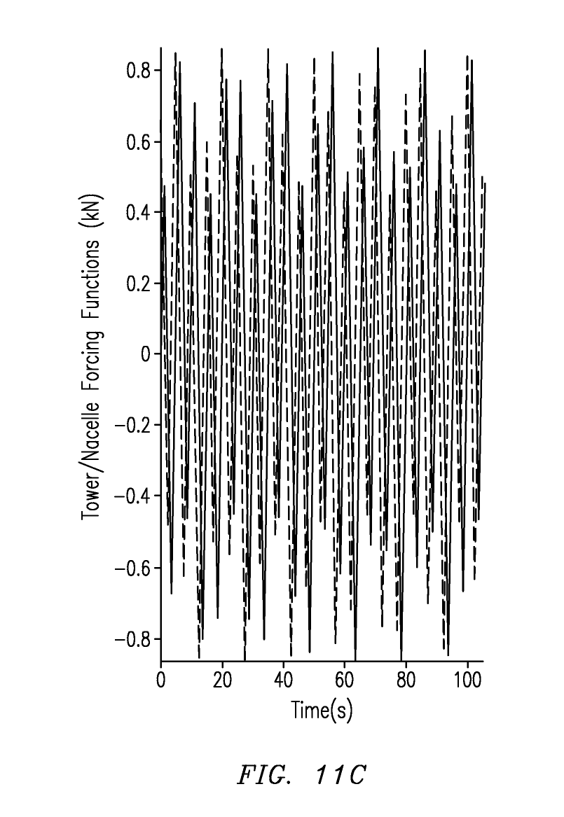

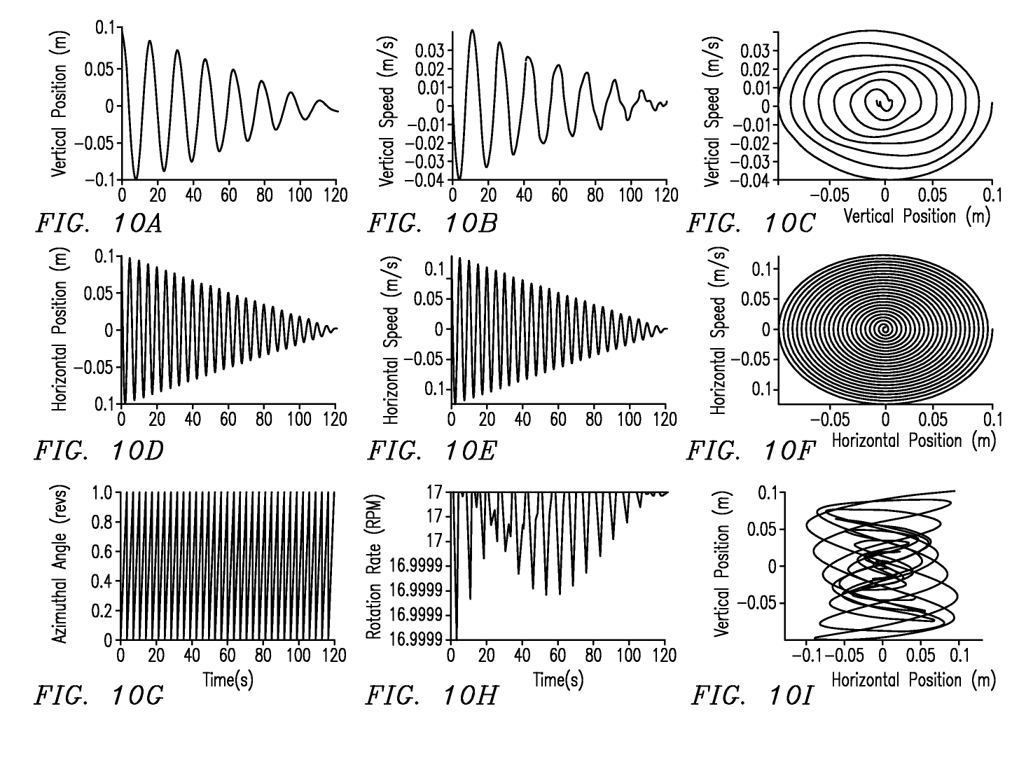

The fact that the turbine's rotor rotates at a rate (Ω) that is independent of the frequencies of the turbine's motion (ωᵢ), means that a systematic movement of the three movable masses 44 must be found that produces driving forces resonant with the turbine's respective X-Y motion. In one aspect of the present invention, Fourier analysis shows that by moving the masses along the blade span at a frequency ω_{DR,i}=Ω−ωᵢ, the desired effect of creating a driving force resonant with the turbine's motion is achieved for i=X and Y. A solution can be found for the systematic movement of the masses 44, e.g. by the controller 46 as described above, that dampens both the X and Y motion simultaneously (see FIGS. 10A-I and FIGS. 11A-C) such that the (off-resonant) driving force of one direction has little to no effect on the other direction. This is verified in the simulation set forth below.

Simulation of Mechanics & Dynamics

FIGS. 10A-10I show the results of simulating a controlled, resonantly-driven damping of an initial 10 cm-amplitude turbine oscillation in the X and Y directions. The vertical motion (X) is shown in FIGS. 10A-10C for the center-of-mass position, velocity, and phase-space over the course of the damping sequence. The horizontal motion (Y) is shown in FIGS. 10D-10F for the center-of-mass position, velocity, and phase-space over the course of the damping sequence. The azimuthal angle θ and angular velocity are shown in FIGS. 10G and 10H while the X-Y motion of the wind turbine is shown in FIG. 10I. The spring constants for the X and Y motion were chosen to give motional periods larger than the period of the rotor's rotation. As shown in FIGS. 10A-10I, one can see a very clean and constant damping of the turbine's motion over a 2-minute simulation period, in which the turbine is constantly generating its rated power. One should note that the rotation rate of the rotor 20a (and therefore power generated by the turbine) is nearly unaffected by the damping system 40, despite the fact that the masses 44 are moving rapidly within the rotor's interior (a rotating frame).

In order to achieve the desired damping, the prescribed motion of the masses was determined analytically, the results of which are shown in FIGS. 11A-11C. Reduced coordinates were used in order to model the motion of the three masses within the blades. Three movable masses 44 were decomposed along a two-axis system to give center-of-mass imbalance positions (“delta's”) for each axis. Analytic solutions were found that describe the prescribed motion that leads to resonantly-driven behavior of the turbine's center of mass. An exemplary solution is further set forth below in the following sequence of equations. The lines in FIG. 11A show the “delta” motion. FIG. 11B shows the position of the three masses 44 over time. One of the three masses was not required to move, but may simply be biased to some finite value in order to provide a reference position. The resulting forcing functions for the X and Y directions are shown in FIG. 11C.

The simulation used the following values that one would find reasonable for a practical system to be employed in future wind turbines. The 10 cm oscillation was fully damped in 2 minutes using three masses m=200 kg each and a range of motion along r of 1-20 m. It is understood that the values used here by no means represent rigid values that are incapable of variation; they simply were reasonable enough to make practical conclusions.

### DEFINITIONS

### Assuming:

M=mass of tower system (platform 12, buoyant member 14, tower 16, nacelle 18)
I_{R}=mass moment of inertia of rotor
m_{R}=mass of hub and blades
kₓ, k_{y}=spring constant in x and y direction, respectively
mᵢ=fixed mass on blade i, for i=1, 2, 3
rᵢ=variable distance of mass hi; from center of rotation

### Definition of Energy: Potential (V) and Kinetic (K)

$$V = \frac{{k}_{x}}{2} {x}^{2 +} \frac{{k}_{y}}{2} {y}^{2}$$

$$K = {K}_{T} + {K}_{R} + {K}_{i}$$

$$where T = tower system ; R = rotor ; and i = mass i . \\ {K}_{T} = \frac{M}{2} ( {\dot{x}}^{2} + {\dot{y}}^{2} )$$

$${K}_{R} = \frac{{M}_{R}}{2} ( {\dot{x}}^{2} + {\dot{y}}^{2} ) + \frac{{I}_{R}}{2} {\dot{θ}}^{2}$$

$${K}_{i} = {\sum }_{t} \frac{{m}_{i}}{2} ( {\dot{x}}_{i}^{2} + {\dot{y}}_{i}^{2} )$$

$$where \text{:}$$

$${x}_{i} - x = {r}_{i} cos {θ}_{i}$$

$${y}_{i} - y = {r}_{i} sin {θ}_{i}$$

$${\dot{x}}_{i} = \dot{x} + {\dot{r}}_{i} cos {θ}_{i} - {\dot{r}}_{i} {\dot{θ}}_{i} sin {θ}_{i}$$

$${\dot{y}}_{i} = \dot{y} + {\dot{r}}_{i} sin {θ}_{i} + {\dot{r}}_{i} {\dot{θ}}_{i} cos {θ}_{i}$$

$${θ}_{i} = \frac{( i - 1 ) 2 π}{3} + θ for i = 1 , 2 , 3$$

$${\dot{θ}}_{i} = \dot{θ}$$

$${K}_{i} = {\sum }_{i} \frac{{m}_{i}}{2} ( {\dot{x}}^{2} + {\dot{y}}^{2} + {\dot{r}}_{i}^{2} {cos}^{2} {θ}_{i} + {\dot{r}}_{i}^{2} {sin}^{2} {θ}_{i} + {r}_{i}^{2} {\dot{θ}}^{2} {sin}^{2} {θ}_{i} + {r}_{i}^{2} {\dot{θ}}^{2} {cos}^{2} {θ}_{i} + 2 \dot{x} {\dot{r}}_{i} cos {θ}_{i} - 2 \dot{x} {r}_{i} \dot{θ} sin {θ}_{i} + 2 \dot{y} {\dot{r}}_{i} sin {θ}_{i} + 2 \dot{y} {r}_{i} \dot{θ} cos {θ}_{i} = {\sum }_{i} \frac{{m}_{i}}{2} ( {\dot{x}}^{2} + {\dot{y}}^{2} + {\dot{r}}_{i}^{2} + {r}_{i}^{2} {\dot{θ}}^{2 +} 2 {\dot{r}}_{l} ( \dot{x} cos {θ}_{i} + \dot{y} sin {θ}_{i} ) - 2 {r}_{i} \dot{θ} ( \dot{x} sin {θ}_{i} - \dot{y} cos {θ}_{i} ) ) \\ For simplicity , assume {m}_{1} = {m}_{2} = m 3 = m \\ K = \frac{1}{2} ( {\dot{x}}^{2} + {\dot{y}}^{2} ) ( M + {M}_{R} + {\sum }_{t} {m}_{t} ) + \frac{1}{2} {I}_{R} {\dot{θ}}^{2} + \frac{m}{2} {\sum }_{i} \dot{r} ( {\dot{r}}_{i}^{2} + {r}_{i}^{2} {\dot{θ}}^{2} ) ) + ( m {\sum }_{i} {\dot{r}}_{i} ( \dot{x} cos {θ}_{i} + \dot{y} sin {θ}_{i} ) ) - ( m \dot{θ} {\sum }_{i} {r}_{i} ( \dot{x} sin {θ}_{i} - \dot{y} cos θ i ) )$$

$$where {m}_{T} = ( M + {M}_{R} + {\sum }_{i} mi ) ; A = ( m {\sum }_{i} {\dot{r}}_{i} ( \dot{x} cos {θ}_{i} + \dot{y} sin {θ}_{i} ) ) ; B = ( - m \dot{θ} {\sum }_{i} {r}_{i} ( \dot{x} sin θ i - \dot{y} cos θ i ) )$$

$$A = m \dot{x} {\sum }_{i} {\dot{r}}_{i} cos {θ}_{i} + m \dot{y} {\sum }_{i} {\dot{r}}_{i} sin {θ}_{i}$$

$$B = - m \dot{θ} \dot{x} {\sum }_{i} {r}_{i} sin {θ}_{i} + m \dot{θ} \dot{y} {\sum }_{i} {r}_{i} cos {θ}_{i}$$

$$Note \text{:} sin ( θ + a ) = sin θcos a + cos θsin a and cos ( θ + a ) = cos θcos a - sin θsin a$$

Common terms arise of the form:

$$\begin{matrix}{\sum }_{i} {C}_{i} cos {θ}_{i} = {C}_{1} cos θ + {C}_{2} cos ( θ + 2 π / 3 ) + {C}_{3} cos ( θ + 4 π / 3 ) \\ = cos θ ( {C}_{1} + {C}_{2} cos ( 2 π / 3 ) + {C}_{3} cos ( 4 π / 3 ) ) - \\ sin θ ( {C}_{2} sin ( 2 π / 3 ) + {C}_{3} sin ( 4 π / 3 )\end{matrix}$$

$$\begin{matrix}{\sum }_{i} {C}_{i} sin {θ}_{i} = {C}_{1} sin θ + {C}_{2} sin ( θ + 2 π / 3 ) + {C}_{3} sin ( θ + 4 π / 3 ) \\ = sin θ ( {C}_{1} + {C}_{2} cos ( 2 π / 3 ) + {C}_{3} cos ( 4 π / 3 ) ) + \\ cos θ ( {C}_{2} sin ( 2 π / 3 ) + {C}_{3} sin ( 4 π / 3 ) )\end{matrix}$$

$$Note \text{:} sin ( 2 π / 3 ) ; = \frac{\sqrt{3}}{2} ;$$

$$sin ( 4 π / 3 ) = - ( \frac{\sqrt{3}}{2} ) ;$$

$$cos ( 2 π / 3 ) = - ( \frac{1}{2} ) ;$$

$$cos ( 4 π / 3 ) = - ( \frac{1}{2} )$$

Like quantities can be found:

$$\begin{matrix}{C}_{1} + {C}_{2} cos ( 2 π / 3 ) + {C}_{3} cos ( 4 π / 3 ) = {C}_{1} - \frac{1}{2} ( {C}_{2} + {C}_{3} ) {C}_{2} sin ( 2 π / 3 ) + \\ {C}_{3} sin ( 4 π / 3 ) \\ = \frac{\sqrt{3}}{2} ( {C}_{2} - {C}_{3} )\end{matrix}$$

This results in the terms A & B to be written as:

$$A = m \dot{x} [ cos θ ( {\dot{r}}_{1} - \frac{1}{2} ( {\dot{r}}_{2} + {\dot{r}}_{3} ) ) - sin θ \frac{\sqrt{3}}{2} ( {\dot{r}}_{2} - {\dot{r}}_{3} ) ] + m \dot{y} [ sin θ ( {\dot{r}}_{1} - \frac{1}{2} ( {\dot{r}}_{2} + {\dot{r}}_{3} ) ) + cos θ \frac{\sqrt{3}}{2} ( {\dot{r}}_{2} - {\dot{r}}_{3} ) ]$$

$$B = - m \dot{x} \dot{θ} [ sin θ ( {r}_{1} - \frac{1}{2} ( {r}_{2} + {r}_{3} ) ) + cos θ \frac{\sqrt{3}}{2} ( {r}_{2} - {r}_{3} ) ] + m \dot{y} \dot{θ} [ cos θ ( {r}_{1} - \frac{1}{2} ( {r}_{2} + {r}_{3} ) ) - sin θ \frac{\sqrt{3}}{2} ( {r}_{2} - {r}_{3} ) ]$$

Similar terms can be found and are recognized to be center-of-mass imbalances δᵢ caused by the arrangement rᵢ of the three masses mᵢ.

### DEFINE:

$${δ}_{1} = {r}_{1} - \frac{1}{2} ( {r}_{2} + {r}_{3} ) ; {δ}_{2} = \frac{\sqrt{3}}{2} ( {r}_{2} - {r}_{3} )$$

$${\dot{δ}}_{1} = {\dot{r}}_{1} - \frac{1}{2} ( {\dot{r}}_{2} + {\dot{r}}_{3} ) ; {\dot{δ}}_{2} = \frac{\sqrt{3}}{2} ( {r}_{2} - {r}_{3} )$$

$${\ddot{δ}}_{1} = {\ddot{r}}_{1} - \frac{1}{2} ( {\ddot{r}}_{2} + {\ddot{r}}_{3} ) ; {\ddot{δ}}_{2} = \frac{\sqrt{3}}{2} ( {r}_{2} - {r}_{3} )$$

δ₁=center of mass imbalance along the ‘1’ axis (axis defined by mass #1) (shown as axis 35 in FIG. 3)
δ₂=center of mass imbalance along the ‘2’ axis (perpendicular to the ‘1’ axis and lying within the rotor plane) (shown as axis 37 in FIG. 3).
From here terms A and B can be reduced to the following using the center-of-mass imbalance terms:

A=m\dot{x}[\dot{δ}₁ cos θ−\dot{δ}₂ sin θ]+m\dot{y}[\dot{δ}₁ sin θ+\dot{δ}₂ cos θ]

B=−m\dot{x}\dot{θ}[δ₁ sin θ+δ₂ cos θ]+m\dot{y}\dot{θ}[δ₁ cos θ−δ₂ sin θ]

Call A+B=K_{XT}; where “XT”=cross terms
The kinetic energy in the cross terms can then simply be written:

K_{XT}=m(\dot{x} cos θ+\dot{y} sin θ)[\dot{δ}₁−δ₂\dot{θ}]−m(\dot{x} sin θ−\dot{y} cos θ)[\dot{δ}₂+δ₁\dot{θ}]

and the Lagrangian can then be written out as (L=K−V):

$$L = \frac{{m}_{T}}{2} ( {\dot{x}}^{2} + {\dot{y}}^{2} ) + \frac{{I}_{R}}{2} {\dot{θ}}^{2} + \frac{m}{2} Σ {\dot{r}}_{i}^{2} + \frac{m}{2} Σ {\dot{r}}_{i}^{2} {\dot{θ}}^{2} + {K}_{XT} - \frac{{k}_{x}}{2} {x}^{2} \frac{{k}_{y}}{2} {y}^{2}$$

∂ₓL=−kₓx; ∂_{y}L=−k_{y}y; ∂_{θ}L=m(\dot{δ}₁−δ₂\dot{θ})(−\dot{x} sin θ+\dot{y} cos θ)−m(\dot{δ}₂+δ₁\dot{θ})(\dot{x} cos θ+\dot{y} sin θ)

∂_{\dot{x}}L=m_{T}\dot{x}+m[(\dot{δ}₁−δ₂\dot{θ})cos θ−(\dot{δ}₂+δ₁\dot{θ})sin θ]

∂_{\dot{y}}L=m_{T}\dot{y}+m[(\dot{δ}₁−δ₂\dot{θ})sin θ−(\dot{δ}₂+δ₁\dot{θ})cos θ]

∂_{\dot{θ}}L=(I_{R}+mΣrᵢ²)\dot{θ}+m[(\dot{x} cos θ+\dot{y} sin θ)(−δ₂)−(\dot{x} sin θ−\dot{y} cos θ)δ₁]

The equations of motion follow:

\hat{x} direction)dₜ∂_{\dot{x}}L−∂ₓL=f_{ext,x}

m_{T}\ddot{x}+kₓx=f_{ext,x}−m[(\ddot{δ}₁−\dot{δ}₂\dot{θ}−δ₂\ddot{θ})cos θ−(\dot{δ}₁−δ₂\dot{θ})\dot{θ} sin θ−(\ddot{δ}₂+\dot{δ}₁\dot{θ}+δ₁\ddot{θ})sin θ−(\dot{δ}₂+δ₁\dot{θ})\dot{θ} cos θ]

\hat{y} direction)dₜ∂_{\dot{y}}L−∂_{y}L=f_{ext,y}

m_{T}ÿ+k_{y}y=f_{ext,y}−m[(\ddot{δ}₁−\dot{δ}₂\dot{θ}−δ₂\ddot{θ})sin θ−(\dot{δ}₁−δ₂\dot{θ})\dot{θ} cos θ−(\ddot{δ}₂+\dot{δ}₁\dot{θ}+δ₁\ddot{θ})cos θ−(\dot{δ}₂+δ₁\dot{θ})\dot{θ} sin θ]

\tilde{θ} direction)dₜ∂_{\dot{θ}}L−∂_{θ}L=Tₑₓₜ

(I_{R}mΣrᵢ²)\ddot{θ}=Tₑₓₜ+m[(\dot{δ}₁−δ₂\dot{θ})(−\dot{x} sin θ+\dot{y} cos θ)−(\dot{δ}₂+δ₁\dot{θ})(−\dot{x} cos θ+\dot{y} sin θ)]+m[\dot{δ}₂(\dot{x} cos θ+\dot{y} sin θ)+δ₂(\ddot{x} cos θ−\dot{x}\dot{θ} sin θ+\ddot{y} sin θ+\dot{y}\dot{θ} cos θ)+\dot{δ}₁(\dot{x} sin θ−\dot{y} cos θ)+δ₁(\ddot{x} sin θ+\dot{x}\dot{θ} cos θ−\ddot{y} cos θ+\dot{y}\dot{θ} sin θ)]

And we define: I_{T}=(I_{R}+mΣrᵢ²)

$$\hat{X} ) {m}_{T} \ddot{x} + {k}_{x} x = {f}_{ext , x} - m [ cos θ ( {\ddot{δ}}_{1} - {\dot{δ}}_{2} \dot{θ} - {δ}_{2} \ddot{θ} - {\dot{δ}}_{2} \dot{θ} - {δ}_{1} {\dot{θ}}^{2} ) - sin θ ( {\ddot{δ}}_{2} + {\dot{δ}}_{1} \dot{θ} + {δ}_{1} \ddot{θ} + {\dot{δ}}_{1} \dot{θ} - {δ}_{2} {\dot{θ}}^{2} ) ] = {f}_{ext , x} + m [ {δ}_{⊥} {\dot{θ}}^{2} + 2 {\dot{δ}}_{2} \dot{θ} + {δ}_{z} \ddot{θ} - {\ddot{δ}}_{1} ) cos θ + ( - {δ}_{2} {\dot{θ}}^{2} + 2 {\dot{δ}}_{1} \dot{θ} + {δ}_{1} \ddot{θ} + {\ddot{δ}}_{2} ) sin θ ] \\ \hat{y} ) {m}_{T} \ddot{y} + {k}_{y} y = {f}_{ext , y} - m [ sin θ ( {\ddot{δ}}_{1} - {\dot{δ}}_{2} \dot{θ} - {δ}_{2} \ddot{θ} - {\dot{δ}}_{2} \dot{θ} - {δ}_{1} {\dot{θ}}^{2} ) + cos θ ( {\ddot{δ}}_{2} + {\dot{δ}}_{2} \dot{θ} + {δ}_{1} \ddot{θ} + {\dot{δ}}_{1} \dot{θ} - {δ}_{2} {\dot{θ}}^{2} ) ] = {f}_{ext , y} + m [ sin θ ( {δ}_{1} {\dot{θ}}^{2} + 2 {\dot{δ}}_{2} \dot{θ} + {δ}_{2} \ddot{θ} - {\ddot{δ}}_{1} ) - cos θ ( - {δ}_{2} {\dot{θ}}^{2} + 2 {\dot{δ}}_{1} \dot{θ} + {δ}_{1} \ddot{θ} + {\ddot{δ}}_{2} ) ] \\ \hat{θ} ) {I}_{T} \ddot{θ} = {𝒯}_{ext} + m [ sin θ ( - \dot{x} ( {\dot{δ}}_{1} - {δ}_{2} \dot{θ} ) - \dot{y} ( {\dot{δ}}_{2} + {δ}_{1} \dot{θ} ) + \dot{y} {\dot{δ}}_{2} + {δ}_{2} ( \ddot{y} - \dot{x} \dot{θ} ) + \dot{x} {\dot{δ}}_{1} + {δ}_{1} ( \ddot{x} + \dot{y} \dot{θ} ) ) + cos θ ( \dot{y} ( {\dot{δ}}_{1} - {δ}_{2} \dot{θ} ) - \dot{x} ( {\dot{δ}}_{2} + {δ}_{1} \dot{θ} ) + \dot{x} {\dot{δ}}_{2} + {δ}_{2} ( \ddot{x} + \dot{y} \dot{θ} ) - \dot{y} {\dot{δ}}_{1} + {δ}_{1} ( \dot{x} \dot{θ} - \ddot{y} ) ) ] = {𝒯}_{ext} + m [ ( {δ}_{2} \ddot{x} - {δ}_{1} \ddot{y} ) cos θ + ( {δ}_{1} \ddot{x} + {δ}_{2} \ddot{y} ) sin θ ]$$

We can now recognize that the center-of-mass imbalance terms lead to effective accelerations in the ‘1’ and ‘2’ directions.

a₁=(δ₁\dot{θ}²+2\dot{δ}₂\dot{θ}+δ₂\ddot{θ}−\ddot{δ}₁) a₂=(δ₂\dot{θ}²−2\dot{δ}₁\dot{θ}−δ₁\ddot{θ}−\ddot{δ}₂)

The equations of motion can then simply be written below as:

$$\hat{x} ) {m}_{T} \ddot{x} + {k}_{x} x = {f}_{ext , x} + m ( {a}_{1} cos θ - {a}_{2} sin θ ) \\ \hat{y} ) {m}_{T} \ddot{y} + {k}_{y} y = {f}_{ext , y} + m ( {a}_{1} sin θ + {a}_{2} cos θ ) \\ \hat{θ} ) \begin{matrix}{I}_{T} \ddot{θ} = {𝒯}_{ext} + m ( ( {δ}_{2} \ddot{x} - {δ}_{1} \ddot{y} ) cos θ + ( {δ}_{1} \ddot{x} + {δ}_{2} \ddot{y} ) sin θ ) \\ = {𝒯}_{ext} - m ( ( {δ}_{1} sin θ + {δ}_{2} cos ) \ddot{x} + ( - {δ}_{1} cos θ + {δ}_{2} sin θ ) \ddot{y} )\end{matrix}$$

### Damping an Oscillation:

Starting with mass in oscillation with amplitude xₙ

x(t)=xₒ cos(ωₒt)

To damp (or resonantly damp) the oscillation, one applies a driving force:

f(t)=fₒ cos(ωₒt)

the solution to the equation of motion:

m\ddot{x}+kx=fₒ cos(ωₒt)

is x(t)=xₒ cos ωₒt+\dot{a}t sin ωₒt where á is the time derivative of the oscillation's amplitude.

$$\dot{x} = - {ω}_{o} {x}_{o} sin {ω}_{o} t + \dot{a} sin {ω}_{o} t + {a}^{′} {ω}_{o} t cos {ω}_{o} t$$

$$\begin{matrix}\ddot{x} = ( \dot{a} - {x}_{o} {ω}_{o} ) {ω}_{o} cos {w}_{o} t + {a}^{′} {ω}_{o} cos {ω}_{o} t - \dot{a} {ω}_{o}^{2} t sin {ω}_{o} t \\ = - {x}_{o} {ω}_{o}^{2} cos {ω}_{o} t - \dot{a} {ω}_{o}^{2} t sin {w}_{o} t + 2 \dot{a} {ω}_{o} cos {ω}_{o} t\end{matrix}$$

$$0 = {f}_{o} cos {ω}_{o} t + ( 2 \dot{a} {ω}_{o} cos {ω}_{o} t ) m$$

$$NOTE \text{:} k = m {ω}_{o}^{2} , and {f}_{o} = 2 \dot{a} m {ω}_{o}$$

Therefore: f(t)=2mωₒ á cos ωₒt
Define T to be the time to fully dampen the oscillation. The rate of change of the amplitude must then be:

$$\dot{a} = \frac{{x}_{0}}{T}$$

$$f ( t ) = \frac{2 m {ω}_{0} {x}_{0}}{T} cos {ω}_{o} t$$

We can then apply this resonant damping technique to the motion of the floating turbine: We begin by applying resonant drives in order to kill the oscillation:

$$\begin{matrix}{a}_{i} ( t ) = {a}_{oi} cos {ω}_{i} t \\ \hat{x} ) \begin{matrix}{a}_{app , x} = {a}_{ox} ( {e}^{{iω}_{x} t} + {e}^{- {iω}_{x} t} ) / 2 \\ = {a}_{1} cos Ω t - {a}_{2} sin Ω t \\ = 1 / 2 [ {a}_{1} ( {e}^{\hat{}} iΩ t + {e}^{\hat{}} - iΩ t ) + i {a}_{2} ( {e}^{\hat{}} iΩ t - {e}^{\hat{}} - iΩ t ) ]\end{matrix} \\ {a}_{ox} ( {e}^{{iω}_{x} t} + {e}^{- {iω}_{x} t} ) = ( {a}_{1} + i {a}_{2} ) {e}^{\hat{}} iΩ t + ( {a}_{1} - i {a}_{2} ) {e}^{\hat{}} - iΩ t ) ] \\ \hat{y} ) \begin{matrix}{a}_{app , y} = {a}_{oy} ( {e}^{{iω}_{y} t} + {e}^{- {iω}_{y} t} ) / 2 \\ = {a}_{1} sin Ω t + {a}_{2} cos Ω t \\ = 1 / 2 [ - i {a}_{1} ( {e}^{\hat{}} iΩ t - {e}^{\hat{}} - iΩ t ) + {a}_{2} ( {e}^{\hat{}} iΩ t + {e}^{\hat{}} - iΩ t )\end{matrix} \\ {a}_{oy} ( {e}^{{iω}_{y} t} + {e}^{- {iω}_{y} t} ) = ( - i {a}_{1} + {a}_{2} ) {e}^{\hat{}} iΩ t + ( i {a}_{1} + {a}_{2} ) {e}^{\hat{}} - iΩ t )\end{matrix}$$

Note: Typically, Ω>>ω_{y}>ωₓ; This allows us to treat this as a Fourier problem in which we envision the fast oscillation Ω as a carrier frequency (as the masses are moving within this moving reference frame) and we associate the frequency of the resonant drive as an off-resonant sideband. Because of this definition of Ω, the positive sideband will be off-resonant and not contribute to the motion of the floating turbine system.

We will now find the prescribed analytic solution for simultaneously damping out motion in both x and y. The center-of-mass imbalances can be written as a linear combination of two frequencies ωⱼ(for j=1,2). cₖⱼ and bₖⱼ represent complex Fourier amplitudes.

δₖ(t)=ΣⱼCₖⱼe^{iω}^{ⱼ}^{t}+bₖⱼe^{-iω}^{ⱼ}^{t} k=1,2; j=1,2

\dot{δ}ₖ(t)=Σⱼ(iωⱼ)Cₖⱼe^{iω}^{ⱼ}^{t}−(iωⱼ)bₖⱼe^{-iω}^{ⱼ}^{t}

\ddot{δ}ₖ(t)=Σⱼ−ωⱼ²(Cₖⱼe^{iω}^{ⱼ}^{t}+bₖⱼe^{-iω}^{ⱼ}^{t})

δ₁=c₁₁e^{iω}^{₁}^{t}+c₁₂e^{iω}^{₂}^{t}+b₁₁e^{-iω}^{₁}^{t}+b₁₂e^{-iω}^{₂}^{t}

δ₂=c₂₁e^{iω}^{₁}^{t}+c₂₂e^{iω}^{₂}^{t}+b₂₁e^{-iω}^{₁}^{t}+b₂₂e^{-iω}^{₂}^{t}

Recall:

\hat{x})aₒₓ(e^{iω}^{ₓ}^{t}+e^{-iω}^{ₓ}^{t})=[e^{i(omega)t}(a₁+ia₂)+e^{-i(omega)t}(a₁−ia₂)]

\hat{y})a_{oy}(e^{iω}^{_{y}}^{t}+e^{-iω}^{_{y}}^{t})=i[e^{i(omega)t}(a₁+ia₂)+e^{-i(omega)t}(a₁−ia₂)]

a₁=δ₁Ω²+2\dot{δ}₂Ω−\ddot{δ}. a₂=δ₂Ω²−2\dot{Ω}₁Ω−\ddot{δ}₂

We can then rewrite the terms above in terms:

$${a}_{1} + i {a}_{2} = {δ}_{1} {Ω}^{2} - 2 i {\dot{δ}}_{1} Ω - {\ddot{δ}}_{1} + {iδ}_{2} {Ω}^{2} + 2 {\dot{δ}}_{2} Ω - i {\ddot{δ}}_{2} - {\sum }_{j = 1}^{2} {e}^{{iω}_{j} t} ( {C}_{1 j} {Ω}^{2 -} 2 iΩ ( {iω}_{j} ) {C}_{1 j} + {ω}_{j}^{2} {C}_{1 j} + i {C}_{2 j} {Ω}^{2} + 2 Ω ( {iω}_{j} ) {C}_{2 j} + {iω}_{j}^{2} {C}_{2 j} ) + {e}^{- {iω}_{j} t} ( {b}_{1 j} {Ω}^{2} - 2 i Ω ( {iω}_{j} ) {b}_{1 j} + {ω}_{j}^{2} {b}_{1 j} + i {b}_{2 j} {Ω}^{2} - 2 Ω ( {iω}_{j} ) {b}_{2 j} + {ω}_{j}^{2} {b}_{2 j} ) = {\sum }_{j = 1}^{2} {e}^{{iω}_{j} t} ( {C}_{1 j} ( {Ω}^{2} + 2 {ω}_{j} Ω + {ω}_{j}^{2} ) + i {C}_{2 j} ( {Ω}^{2} + 2 {ω}_{j} Ω + {ω}_{j}^{2} ) ) + {e}^{- {iω}_{j} t} ( {b}_{1 j} ( {Ω}^{2 -} 2 {ω}_{j} Ω + {ω}_{j}^{2} ) + i {b}_{2 j} ( {Ω}^{2} - 2 {ω}_{j} Ω + {ω}_{j}^{2} ) ) \\ {a}_{1} + i {a}_{2} = {\sum }_{j = 1}^{2} {{e}^{{iω}_{i} t} ( Ω + {ω}_{i} )}^{2} ( {C}_{1 j} + i {C}_{2 j} ) + {{e}^{- {iω}_{j} t} ( Ω - {ω}_{j} )}^{2} ( {b}_{1 j} + i {b}_{2 j} ) \\ {a}_{1} = i {a}_{2} = {δ}_{1} {Ω}^{2} + 2 i {\dot{δ}}_{1} Ω - {\ddot{δ}}_{1} - {iΩ}^{2} {δ}_{2} + 2 {\dot{δ}}_{2} Ω - {\ddot{δ}}_{2} = {\sum }_{j = 1}^{2} {e}^{{iω}_{j} t} ( {C}_{1 j} {Ω}^{2 +} 2 i ( {iω}_{j} ) Ω {C}_{1 j} + {ω}_{j}^{2} {C}_{1 j} - {iΩ}^{2} {C}_{2 j} + 2 Ω ( {iω}_{j} ) {C}_{2 j} + {ω}_{j}^{2} {C}_{2 j} ) ) \\ {e}^{- {iω}_{j} t} ( {b}_{1 j} {Ω}^{2 +} 2 i ( - {iω}_{j} ) Ω {b}_{1 j} + {ω}_{j}^{2} {b}_{1 j} - {iΩ}^{2} {b}_{2 j} + 2 Ω ( - {iω}_{j} ) {b}_{2 j} + {ω}_{j}^{2} {b}_{2 j} ) ) = {\sum }_{j = 1}^{2} {e}^{{iω}_{j} t} ( {C}_{1 j} ( {Ω}^{2} - 2 {ω}_{j} Ω + {ω}_{j}^{2} ) - i {C}_{2 j} ( {Ω}^{2} - 2 {ω}_{j} Ω + {ω}_{j}^{2} ) ) + {e}^{- {iω}_{j} t} ( {b}_{1 j} ( {Ω}^{2} + 2 {ω}_{j} Ω + {ω}_{j}^{2} ) - i {b}_{2 j} ( {Ω}^{2} + 2 {ω}_{j} Ω + {ω}_{j}^{2} ) )$$

$${a}_{1} - i {a}_{2} = {\sum }_{j = 1}^{2} {{e}^{{iω}_{j} t} ( Ω - {ω}_{j} )}^{2} ( {C}_{1 j} - i {C}_{2 j} ) + {{e}^{- {iω}_{j} t} ( Ω + {w}_{j} )}^{2} ( {b}_{1 j} - i {b}_{2 j} )$$

We can then rewrite the above equations in this reduced form:

$$\hat{x} ) {a}_{ox} ( {e}^{{iω}_{x} t} + {e}^{- {iω}_{x} t} ) == {\sum }_{j = 1}^{2} {( Ω + {ω}_{j} )}^{2} ( {C}_{1 j} + i {C}_{2 j} ) {e}^{i ( Ω + {w}_{j} ) t} + {( Ω - {ω}_{j} )}^{2} ( {b}_{1 j} + i {b}_{2 j} ) {e}^{i ( Ω - {ω}_{j} ) t} + {( Ω - {ω}_{j} )}^{2} ( {C}_{1 j} - i {C}_{2 j} ) {e}^{- i ( Ω - {ω}_{j} ) t} + {( Ω + {ω}_{j} )}^{2} ( {b}_{1 j} - i {b}_{2 j} ) {e}^{- i ( Ω + {ω}_{j} ) t} \\ \hat{y} ) \frac{{a}_{oy}}{i} ( {e}^{{iω}_{y} t} + {e}^{- {iω}_{y} t} ) = {\sum }_{j = 1}^{2} {( Ω + {ω}_{j} )}^{2} ( {C}_{1 j} + i {C}_{2 j} ) {e}^{i ( Ω + {w}_{j} ) t} + {( Ω - {ω}_{j} )}^{2} ( {b}_{1 j} + i {b}_{2 j} ) {e}^{i ( Ω - {ω}_{j} ) t} - {( Ω - {ω}_{j} )}^{2} ( {C}_{1 j} - i {C}_{2 j} ) {e}^{- i ( Ω - {ω}_{j} ) t} - {( Ω + {ω}_{j} )}^{2} ( {b}_{1 j} - i {b}_{2 j} ) {e}^{- i ( Ω + {ω}_{j} ) t}$$

Again, the positive sidebands (‘Ω+ωⱼ’ terms) will not contribute to any damping, while the negative sidebands (‘Ω−ωⱼ’ terms) will do all of the damping. Therefore call ωₓ=Ω−ω₁; ω_{y}=Ω−ω₂.

The above can then be written in matrix form, and solved for the c's and b's:

$$\begin{matrix}0 & & 1 & i & 0 & 0 & 1 & - i & 0 & 0 & & {c}_{11} \\ 0 & & 0 & 0 & 1 & i & 0 & 0 & 1 & - i & & {c}_{21} \\ {a}_{ox} / {( Ω - {ω}_{1} )}^{2} & & 1 & - i & 0 & 0 & 1 & i & 0 & 0 & & {c}_{12} \\ 0 & = & 0 & 0 & 1 & - i & 0 & 0 & 1 & i & & {c}_{22} \\ 0 & & i & - 1 & 0 & 0 & - i & - 1 & 0 & 0 & & {b}_{11} \\ 0 & & 0 & 0 & l & - 1 & 0 & 0 & - i & - 1 & & {b}_{21} \\ 0 & & - i & - 1 & 0 & 0 & i & - 1 & 0 & 0 & & {b}_{12} \\ {a}_{oy} / {( Ω - {ω}_{2} )}^{2} & & 0 & 0 & - i & - 1 & 0 & 0 & l & - 1 & & {b}_{22}\end{matrix}$$

The solution above can then be inserted into the definition of the center of mass imbalances δₖ.

and δₖ(t)=Σⱼ₌₁²Cₖⱼe^{iwjt}+bₖⱼe^{-iwjt}k=1,2

These imbalances then dictate the motion of the three masses. It is interesting to note that to fulfill the requirement for the center-of-mass imbalances, only two of the three masses need to be in motion in certain embodiments. The third mass may simply sit idle at a preset location.

While various embodiments of the present invention have been shown and described herein, it will be obvious that such embodiments are provided by way of example only. Numerous variations, changes and substitutions may be made without departing from the invention herein. Accordingly, it is intended that the invention be limited only by the spirit and scope of the appended claims.

The invention claimed is:

1. A system for damping motion of a wind turbine comprising:
a sensor operable to provide a signal representative of a motion of the wind turbine in at least one degree of freedom;
a movable mass disposed on a blade of the wind turbine, the movable mass configured for movement along a length of the blade; and
an actuator associated with the movable mass for moving the movable mass along the length of the blade; and
a controller communicably associated with the sensor and the actuator;
wherein the controller is operable to receive the signal from the sensor and to responsively direct the actuator to move the movable mass along the length of the blade to a degree effective to dampen motion of the wind turbine in the at least one degree of freedom.

2. The system of claim 1, wherein the sensor comprises a first sensor configured to sense motion of the wind turbine in a first degree of freedom of the wind turbine and a second sensor configured to sense motion of the wind turbine in a second degree of freedom of the wind turbine.

3. The system of claim 2, wherein the wind turbine comprises a plurality of blades, wherein selected ones of the plurality of blades comprise the movable mass and the actuator, and wherein the controller is configured to receive the signal from the first and second sensors and direct movement of the movable mass via the actuator on at least one of the plurality of blades to a degree effective to dampen motion of the wind turbine in the first degree of freedom and the second degree of freedom.

4. The system of claim 1, wherein the blade comprises an I-shaped spar having a vertical extent and a track extending longitudinally along the vertical extent, and wherein the actuator is configured to move the movable mass a predetermined distance along a length of the track.

5. The system of claim 4, wherein the selected ones of the plurality of blades comprise a first movable mass and a second movable mass disposed on corresponding tracks on opposed sides of the vertical extent of the I-shaped spar, and wherein the first movable mass and the second movable mass are each configured to move a predetermined distance along a length of the track.

6. The system of claim 1, wherein the first degree of freedom is representative of a vertical motion of the wind turbine, wherein the second degree of freedom is representative of a horizontal motion of the wind turbine, and wherein the controller is configured to move the movable mass on the selected ones of the plurality of blades to a degree effective to provide a pair of driving forces on the wind turbine that are resonant with the vertical motion and the horizontal motion of the wind turbine.

7. The system of claim 1, wherein the wind turbine is a floating wind turbine.

8. A method for operating a wind turbine having a plurality of blades, the method comprising:
generating a signal representative of an extent and a phase of motion of the wind turbine in at least one degree of freedom via at least one sensor; and
executing a forcing function in response to the generated signal effective to determine driving forces necessary to quench the motion of the wind turbine in the at least one degree of freedom.

9. The method of claim 8, further comprising generating the one or more forces by moving masses disposed on at least one of the plurality of blades a predetermined distance as determined by the forcing function to quench the motion of the wind turbine in the at least one degree of freedom.

10. The method of claim 9, wherein the at least one degree of freedom comprises a first degree of freedom and a second degree of freedom, and wherein the motion of the wind turbine is quenched in the first and second degree of freedom simultaneously.

11. A wind turbine blade for use with a wind turbine comprising:
a body having a longitudinal axis;
a movable mass disposed on the body effective to change a center of mass of the blade upon movement of the mass along the longitudinal axis; and
an actuator interfacing with the movable mass and effective to selectively move the movable mass a predetermined distance along the longitudinal axis.

12. The wind turbine blade of claim 11, wherein the body further comprises:
an I-shaped spar having a vertical extent; and
a track extending longitudinally along the vertical extent;
wherein the movable mass is configured for movement along the track.
